(19) United States
(12) Patent Application Publication
(10) Pub. No.: US 2004/0018792 A1
(43) Pub. Date: Jan. 29, 2004

(54) Bedding under sheet

(76) Inventor: Kazutoshi Kaizuka, Fukuoka City (JP)

Correspondence Address: Squire, Sanders & Dempsey L.L.P., 14th Floor, 801 S. Figueroa Street, Los Angeles, CA, 90017-5554, US

(21) Appl. No.: 10/282,348

(22) Filed: Oct. 29, 2002

(30) Foreign Application Priority Data
Jul. 26, 2002 (JP) 2002-004642

(51) Int. Cl. B32B 5/16

(52) U.S. Cl. 442/327; 428/323; 428/331

(57) ABSTRACT

A bedding under-sheet which serves to promote health in such ways as strengthening the immune system of the user, stabilizing mood, improving bodily functions, expelling waste products, improving respiratory function, relieving fatigue, and improving stiff shoulders and stiff neck by generating anions and magnetic force from the surface thereof. The bedding under-sheet includes a multi-element mineral powder formed by crushing a multi-element mineral which is blended into the under-sheet itself

### BACKGROUND OF THE INVENTION

1. Field of the Invention

The present device relates to a bedding under-sheet to be placed under a sheet, pad, or coverlet, and in particular, to an improved bedding under-sheet which promotes the health of the user by way of anions and far-infrared emissions.

2. General Background and State of the Art

For futons used for bedding, the surface of the futon is preferably covered by a mattress pad or simply a sheet, and for other types of bed mattresses, it is common to cover the mattress with a mattress pad. As people sleep on sheets placed over mattress pads, slippage and wrinkles in the sheets or mattress pads readily occur. In order to limit this slipping and wrinkling, it is effective to lay an anti-slip under-sheet below the sheet or the mattress pad.

In terms of conventional anti-slip under-sheets, elastic sheets formed from an elastic material, such as polyester (generally formed as a mesh), and those wherein a nonwoven fabric is affixed to one side of the elastic under-sheet are known.

### INVENTION SUMMARY

However, while conventional anti-slip sheets are not used exclusively for bedding products, no anti-slip sheets of any type have been marketed which are capable of generating anions and far-infrared emissions from the surface thereof so as to strengthen the immune system of the user, stabilize mood, improve bodily functions, expel waste products, improve respiratory function, relieve fatigue, or provide the types of health benefits provided by exposure to anions and far-infrared emissions.

An object of the present device is to provide a novel bedding under-sheet which is an exclusive bedding product and which generates anions and far-infrared emissions from the surface thereof and, consequently, serves to promote health in such ways as strengthening the immune system of the user, stabilizing mood, improving bodily functions, expelling waste products, improving respiratory function, relieving fatigue, and relaxing stiff shoulder and neck muscles.

In terms of the means for achieving the aforementioned object, the bedding under-sheet of the present device combines a bedding under-sheet preferably used by laying it under a sheet, pad, or coverlet, characterized in that a multi-element mineral powder, formed by grinding a multi-element mineral, is blended into the material of the under-sheet.

In this bedding under-sheet, a multi-element mineral powder is blended into the material of the under-sheet, and therefore, anions are continuously generated and emitted from the surface thereof. For the user, blood circulation is improved by the action of these anions serving to strengthen the immune system, stabilize mood, improve bodily functions, expel waste products, improve respiratory function, and relieve fatigue. Furthermore, electromagnetic waves with wavelengths of 4 to 14 μm (weak energy) emitted by multi-element minerals in the under-sheet electrically modify the surroundings of the nuclei of atoms and cause an excited state (oscillation) in substances comprising the same; consequently, water cluster polymers are cleaved and shortened, the volume of the water is reduced, and the specific gravity is increased; thus causing sufficient contact of the outer membranes of animal cells by the water (free water), which promotes the permeation of the cell by both Ca+ and water, and has the effect of activating various cellular functions. Accordingly, blood flow is promoted and cells are activated thereby promoting good health.

Furthermore, the bedding under-sheet of the present device provides a bedding under-sheet used by laying it under a sheet, pad, or coverlet, the under-sheet is characterized in that a multi-element mineral powder, formed by grinding a multi-element mineral, is combined with a far-infrared emitting powder, formed by grinding a far-infrared emitting material, and the combination is blended into the under-sheet itself.

The under-sheet thus comprises far-infrared emitting powder in addition to multi-element mineral powder, such that far-infrared energy is radiated from this far-infrared emitting powder, and the body can be warmed from within. Consequently, the blood circulation in the capillary vessels is also improved, and therefore, blood flow is promoted, which alleviates stiff shoulders and stiff neck and allows for promotion of good health.

### BRIEF DESCRIPTION OF THE DRAWINGS

FIG. 1 is a perspective view showing one example of a bedding under-sheet.

### DETAILED DESCRIPTION OF THE PREFERRED EMBODIMENTS

Hereafter, modes of embodiment of the device are described by way of the examples shown in the drawings.

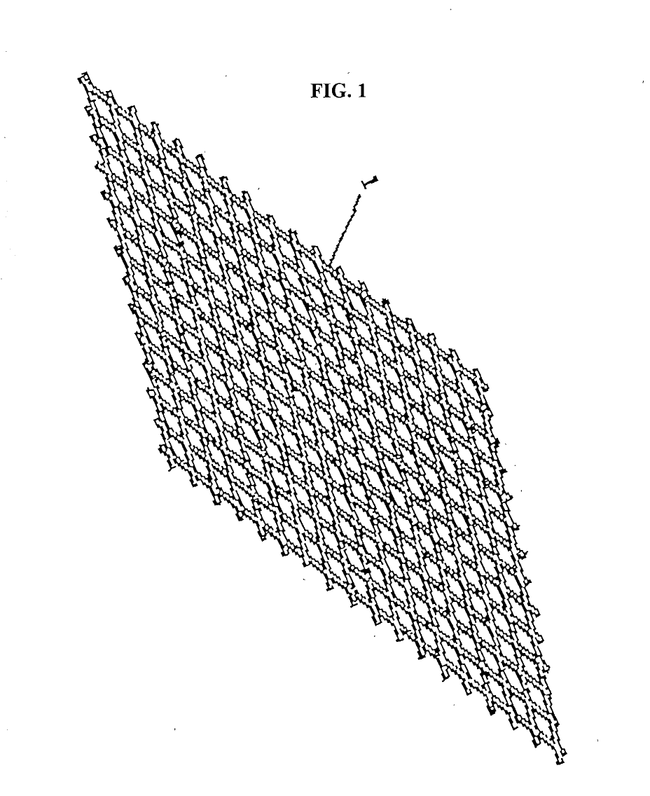

FIG. 1 is a perspective view illustrating a bedding under-sheet 1 according to one example. The bedding under-sheet 1 is formed as a mesh from, for example, a synthetic resin, such as polyester, and an elastic material, such as a synthetic rubber, and the surface thereof takes the form of protrusions and depressions.

A multi-element mineral powder produced by crushing a multi-element mineral is blended into the under-sheet 1. The term multi-element mineral refers to minerals comprising a good balance of a plurality of elements, such as tourmaline, perlite, and pitchstone, which are composed primarily of silicon. The multi-element mineral powder is formed by crushing a multi-element mineral, such as perlite, in a bowl mill to a fineness of approximately 1 to 3 microns. It is preferable that a mixture of 2 or more types of multi-element mineral powders be used. Note that perlite comprises the components shown in the approximate percentages listed below in Table 1.

TABLE 1

| | |
|---|---|
| silicon dioxide (SiO₂) | 71.94% |
| aluminum oxide (A1₂0₃) | 14.94% |
| ferrous oxide (Fe₂O₃) | 2.54% |
| magnesium oxide (MgO) | 0.44% |
| calcium oxide (CaO) | 2.47% |
| alkali oxide (K₂O + Na₂O) | 6.87% |
| manganese oxide (MnO) | 0.03% |
| phosphoric anhydride (P₂O₅) | 0.14% |
| ignition loss | 3.43% |
| drying loss (at 110 ° C.) | 0.07% |
| other, titanium | Trace |

The multi-element mineral powder may be mixed as a powder with the primary materials of the under-sheet 1 without further processing, or the multi-element mineral powder may be mixed with water, and after heating or pressurization, the supernatant may be used without further processing, or a powder produced by freeze-drying or spray-drying thereof may be used.

Furthermore, 2 to 3 weight percent of the multi-element mineral powder may be mixed into a solution of 50% polyvinyl chloride (PVC), 40% dioctyl phthalate (plasticizer, DOP) and 10% polyester, and the multi-element mineral powder may be blended into the under-sheet 1 by immersing (dipping) the under-sheet 1 in this solution. Furthermore, the multi-element mineral powder may be blended into the under-sheet 1 by applying or spraying a solution into which the multi-element mineral powder has been blended onto the under-sheet. In this case, by immersing the surface of the under-sheet 1, a layer is formed which adheres by impregnation, wherein the multi-element mineral powder is blended into this layer. In the present device, the description wherein a multi-element mineral powder is blended into an under-sheet itself includes each of the foregoing processes and processes similar thereto.

Accordingly, when the bedding under-sheet 1 according to the present example is used, the bedding under-sheet 1 is laid under a sheet which covers a futon or under a pad which is laid on a mattress, and is used for sleeping. If the bedding under-sheet 1 is laid under a sheet or pad, this bedding under-sheet 1 can prevent the sliding of this sheet or pad, and limit the occurrence of slippage and wrinkles. Note that this bedding under-sheet 1 may also be made without an anti-slip property.

Furthermore, as the multi-element mineral powder, formed by crushing a multi-element mineral, is blended into the under-sheet 1 itself, anions are constantly generated and this acts on the blood, whereby the human body enters a state tending to slightly negative ions, bringing the body into balance, activating the metabolism, preventing aging, and promoting good health. Furthermore, as a result of the weak energy radiated by the multi-element mineral powder, water cluster polymers are cleaved and shortened, decreasing the volume of the water and increasing the specific gravity so that the water (free water) can sufficiently contact the external membranes of animal cells. Accordingly, water permeation is promoted and various cellular functions are activated, resulting in promotion of blood flow and cellular activation, so that good health is promoted.

Furthermore, in the present device, in addition to the multi-element mineral powder, a far-infrared emitting powder may be blended into the under-sheet 1 itself. If this far-infrared emitting powder is blended therein, the body is warmed from the interior as a result of the far-infrared radiated from this far-infrared emitting powder. Consequently, the blood circulation in the capillary blood vessels is improved, and therefore, blood flow is promoted and shoulder stiffness and neck stiffness are alleviated, and good health is promoted.

Note that, far-infrared emitting materials include alumina (Al₂O₃), titanium oxide (TiO₂), ferrite (Fe₂O₂), chromium oxide (CrO₃), silica (SiO₂), yttria (Y₂O₂), magnesia (MgO), and similar materials which are crushed, and the resulting powdered material is used alone or in combinations.

Modes of embodiment of the present device have been described above, but the specific constitution of this device is not limited to the modes of embodiment described above, and the present device includes design variations, etc., which do not go beyond the gist of the device.

In other words, it is sufficient that the bedding under-sheet 1 according to the present device be such that a multi-element mineral powder (in some cases far-infrared emitting powder is combined therewith) be blended into the under-sheet 1 itself; there are no limits upon the material for the under-sheet 1 itself, the manufacturing method therefor, or the method whereby the multi-element mineral powder is blended therein. Furthermore, in the present device, the term “under-sheet” may include an under-sheet having a multi-layer structure wherein a non-woven fabric is affixed to one side of an elastic sheet formed of an elastic material; the multi-element mineral powder may be blended into either the elastic sheet or the non-woven fabric, or into both of these.

Effects of the Device

As described above, in the bedding under-sheet of the present device, a multi-element mineral powder, formed by crushing a multi-element mineral, is blended into the under-sheet itself, anions and electromagnetic waves (weak energy) are generated, and these act on the blood causing the human body to enter a state which tends towards slightly negative ions, whereby a good body balance is achieved, the metabolism is activated, aging of the body is prevented, and good health is promoted; this further serves to strengthen the immune system, stabilize mood, improve bodily functions, expel waste products, improve respiratory function, relieve fatigue, etc., and comfortable sleep can be achieved.

Furthermore, in the present device, in addition to a multi-element mineral powder, far-infrared emitting powder is blended into the under-sheet itself, and as a result of the far-infrared emitted from this far-infrared emitting powder, the body is warmed from the interior. Consequently, the blood circulation in the capillary blood vessels is improved, and therefore, blood flow is promoted and shoulder stiffness and neck stiffness are alleviated, and good health is promoted.

What is claimed is:

1. A bedding under-sheet for use as a sheet, under-sheet, pad, or coverlet, comprising:
a bedding sheet, and
a multi-element mineral powder, formed by grinding a multi-element mineral, blended into the bedding sheet.

2. A bedding under-sheet for use as a sheet, under sheet, pad, or coverlet, comprising:
a bedding sheet, and
a multi-element mineral powder, formed by grinding a multi-element mineral, and a far-infrared emitting powder, formed by grinding a far-infrared emitting material, both blended into the under-sheet.

3. The bedding under-sheet of claim 1 wherein said multi-element mineral powder is selected from the group consisting of tourmaline, perlite and pitchstone.

4. The bedding under-sheet of claim 2 wherein said multi-element mineral powder is selected from the group consisting of tourmaline, perlite and pitchstone.

5. The bedding under-sheet of claim 2 wherein said far-infrared emitting powder is one or more materials selected from the group consisting of alumina, titanium oxide, ferrite, chromium oxide, silica, yttria and magnesia.

6. The bedding under-sheet of claim 1 wherein said multi-element mineral powder is processed prior to being blended into the bedding sheet.

7. The bedding under-sheet of claim 1 wherein said bedding sheet if formed from a combination of a synthetic resin and an elastic material.
